(19) United States
(12) Patent Application Publication
(10) Pub. No.: US 2023/0260278 A1
(43) Pub. Date: Aug. 17, 2023

(54) SYSTEM AND METHOD FOR CLASSIFICATION OF CROPS USING MULTI-CLASS MACHINE LEARNINGG TECHNIQUES

(71) Applicant: Deepspatial INC., Toronto (CA)

(72) Inventors: Bushra Zaman, Bengaluru (IN); Rajiv Muradia, Toronto (CA); Rahul Kushwah, Toronto (CA)

(21) Appl. No.: 18/107,307

(22) Filed: Feb. 8, 2023

Related U.S. Application Data
(60) Provisional application No. 63/307,982, filed on Feb. 8, 2022.

(51) Int. Cl. G06V 20/10; G06V 10/764; G06V 10/774

(52) U.S. Cl. CPC G06V 20/188; G06V 10/764; G06V 10/774

(57) ABSTRACT

The invention relates to an agricultural analytics platform that enables farmers, agriculturists and decision makers to classify crops and invasive species using multiclass machine learning technique. The agricultural analytics platform uses data assimilation techniques to understand the changing landscape of agriculture. The invention discloses an improved set of layered solutions which help in estimating crop yields and provide insights for generating maximum output. Advanced Artificial Intelligence (AI) algorithms and statistical analyses are used to provide solutions for agricultural problems such as crop rotation, crop selection, crop yield, etc.

### RELATED APPLICATIONS

This application is related to, and claims priority to the Provisional Application Ser. No. 63/307,982, filed Feb. 8, 2022.

The subject matter of the related applications, each in its entirety, is expressly incorporated herein.

### FIELD OF THE INVENTION

The invention relates to an agricultural analytics platform that enables farmers, agriculturists and decision makers to classify crops and invasive species using this multiclass machine learning technique. The agricultural analytics platform uses data assimilation techniques to understand the changing landscape of agriculture.

The invention discloses an improved set of layered solutions which help in estimating crop yields which in turn provide insights for generating maximum output. This invention is implemented using an advanced Artificial Intelligence (AI) engine to provide solutions for agricultural problems including crop rotation, crop selection, crop yield etc. The agricultural analytical platform provides AI solutions to help the stakeholders make data driven decisions by using the geospatial insights provided by the Machine Learning Engine as well as plan, manage and organize crop management activities on the farm.

### BACKGROUND OF THE INVENTION

An array of spatial data and advanced machine learning and artificial intelligence techniques have empowered scientists and business alike in extracting valuable information and use it for the betterment of mankind. The technical advancements have redefined agriculture over the years and have affected the farming industry in many ways. Agriculture is the major occupation in most of the countries worldwide and with each passing day, the population is rising which, as per UN projections will increase from 7.5 billion to 9.7 billion in 2050, adding more pressure on land as the cultivable area will only increase by 4% while the food production will have to increase by 60% by 2050. However, traditional methods are not enough to handle this huge demand. For dealing with the increased demand, it is useful and relevant to have an estimation of production per square units. AI techniques are swiftly becoming a part of the evolving agricultural technology. The proposed solution introduces a machine learning classification technique which classifies different crops based on various physical characteristics of the plant species and other assimilated data.

The most elementary geospatial data recognized by everyone is a map—which in its basic usage model solves the problems of distance and direction. But today, geospatial intelligence can solve more complex problems.

Much work has been done using remote sensing data for land cover mapping and crop discrimination and classification also have been done in the past. Various methods have been applied for classifying remotely sensed data, e.g., nearest neighbor, maximum likelihood classifier (MLC), artificial neural networks, support vector machines and, more recently, the relevance vector machine (RVM). RVMs lend themselves to a natural extension to the multiclass case and to determine hyper parameters in a single run. RVMs also ensure a fast and efficient classification process and have been successfully applied in different fields where they have been shown to be more suitable for real-time implementation with reduced computational complexity and comparable accuracies. RVM technique for detection of micro-calcification clusters in digital mammograms has been proposed in the past. It has been observed that although the RVM training time was greater than that of support vector machines (SVMs), the testing time was much less for RVM while maintaining its best detection accuracy. An extension of the RVM technique to multiclass problems was derived and was applied to digit classification. A two-level hierarchical hybrid SVM-RVM model has also been used to perform text classification. Recently the RVM multi-classifier has been introduced for classification of remotely sensed data, where the data sets were classified based on reflectance in three spectral wavebands.

The current invention uses the probabilistic nature of the RVM-based classification. In some implementations, the RVMs were used for hyper spectral data classification. This invention demonstrated that RVMs produced comparable classification accuracy with a significantly smaller number of RVs and, therefore, produced a much faster testing time. While RVM has been successful in producing comparable classification accuracies and probabilistic estimates which help understand the class uncertainty on a per case basis, failure to incorporate ancillary data into the classification algorithm would fail to fully exploit the breadth and depth of available information. By incorporating ancillary data into traditional classification algorithms as logical channels (combining the ancillary data as an additional data layer with the spectral bands), the full range of available information in the ancillary data can be used.

### Solution to Problem of Multi Class Classification of Crops

The invention uses a data assimilation technique using a multiclass relevance vector machine approach which employs Bayesian statistics for evolutionary computation as a modeling tool where ancillary information, relevant to the type of study being conducted, is merged with the reflectance data. The data sets were assimilated in a non-redundant fashion with LAI, vegetation indices (VIs), and reflectance as inputs.

In one embodiment, this novel technique employs Bayesian statistics for evolutionary computation as a modeling tool and combines it with additional ancillary data related to Location Area Identity (LAI), vegetation indices (VIs), and reflectance as inputs for multi-class classification of crops accurately. The model was prepared mainly for crop classification purposes, and inputs that are more sensitive to vegetation differences were used in the training set. In an exemplary implementation, the data was collected from Little Washita Watershed in Oklahoma, USA and was used to implement and assess the model. A rigorous accuracy assessment has been done to assure that the allocation of classes is not accidental and has been learned by the model. The receiver operating characteristic (ROC) curves are used to check the multiclass RVM model performance. It has also been observed that the model works well with small datasets as well.

### SUMMARY OF THE INVENTION

A computer implemented method and system for agricultural analytics that systemizes reflectance, derived vegetation indices, field measurements of crop physiological characteristics fused with geospatial information to help classify crop cover and estimate the area of crop growth.

In embodiments, the agricultural analytics platform may include one or more applications for enabling farming. The agricultural analytics platform uses a layered set of solutions, which classify the different agricultural crops along with added value of identifying the yield per square unit.

In some embodiments, the agricultural analytics platform may rapidly access various forms of data related to farming, which allows the platform to identify highly specific, extremely valuable information using spatial information systems and custom maps.

In some embodiments, the agricultural analytics platform may assimilate different datasets with tagged location information and integrate it with the crop physiological data to be used as an input with a defined level of granularity. Through the combined use of assimilated data and location intelligence, the agricultural analytics platform may detect patterns in the images and classify crops based on the detected patterns.

In some embodiments, the agricultural analytics platform may evaluate the effectiveness of using ancillary data along with spectral reflectance data to improve the interpretability of class prediction as compared to the use of only spectral reflectance for classification.

In embodiments, the agricultural analytics platform may perform the process of data ingestion in raster format; converting the data into an ASCII format through the use of an artificial intelligence engine; the artificial intelligence engine may then transform the data into a number format. The process implemented in analytical platform may be used to prepare the training and test sets from the ASCII file, build, evaluate and train the data model to classify the data for prediction. Subsequently, the process implemented on the platform may perform a multiclass supervised classification on the data and the results may be saved. In some embodiments, the result of the evaluation maybe saved in .cvs file(s). The csv file(s) may then be converted to ASCII file(s), which in turn may be converted to image file(s). The agricultural analytics platform may have an additional capability of adding a specified projection system to the classified image which can be assigned to any geospatial software for further analysis.

The agricultural analytics platform may implement a process related to methodology for crop classification using a supervised leaning machine. In different embodiments, the weather data, the vegetation indices data and the reflectance data may be utilised for crop classification. The weather data, the vegetation indices data and the reflectance data may further have geo-location data tagged to it. The tool may recommend the types of crops to be grown in a particular area and its expected yield. The agricultural analytics platform may include a feature of weed/invasive species classification as well.

An embodiment of a computer implemented analytical platform for classification and prediction of different vegetation in a geographical area is disclosed, wherein the computer implemented analytical platform comprises: a data collection module configured to aggregate data from at least one data source; an image processing module to convert image data wherein each pixel has a reflectance value (float value) wherein the reflectance value may be a physical property of the surface being analysed, into a matrix of numbers, wherein the matrix of numbers may be utilised by the machine learning artificial intelligence algorithms; a feature engineering module configured to map the geospatial data for at least one geographical area; an agricultural analytical engine implementing machine learning algorithms, which are trained using a test dataset, wherein the test dataset includes selection of features that are selected by the feature engineering module to optimise the set goals; a recommendation module for prediction and classification of the outcomes based on a set of goals, and a resynthesis module to convert the outcome, which is a classified matrix of numbers, back to an image and assign a geospatial projection to the image as per set goals.

In embodiments, the prediction and classification of vegetation may be related to crops as well as invasive species.

In embodiments, the geospatial features of the geographical area may be used for prediction and crop classification as well as classification of the invasive species.

In embodiments, the testing of collected data may be performed using supervised classification. The supervised classification may be based on statistical learning theory.

The classification of vegetation data may be based on statistical techniques which include creating confusion matrices, receiver operating characteristic (ROC) graphs, and Kappa coefficients.

In embodiments, the collected data and the other data may be fused with remotely sensed data including but not limited to reflectance and vegetation indices with field measurements of crop physiological characteristics.

An embodiment of a computer implemented analytical method for classification and prediction of different vegetation in a geographical area is also disclosed, wherein the computer implemented analytical method comprises: collecting data from at least one data source; converting image data in which each pixel has a reflectance value (float) wherein the reflectance value may be a physical property of the surface being analysed, into a matrix of numbers, wherein the matrix of numbers may be utilised by the machine learning artificial intelligence algorithms; mapping a geospatial data for at least one geographical area; implementing machine learning algorithms, which may be trained using a test dataset, wherein the test dataset includes selection of data features to optimize the set goals; classifying the outcomes based on the set goals; converting the outcome which is a classified the matrix of numbers back to an image and assigning a geospatial projection to the image as per set goals.

### BRIEF DESCRIPTION OF FIGURES

FIG. 1 illustrates the environment of a computer implemented analytical platform in an embodiment of the present invention;

FIG. 2 illustrates the different components of a computer implemented analytical platform in an embodiment of the present invention;

FIG. 3 illustrates different components of an agricultural analytics module in an embodiment of the present invention;

FIG. 4A illustrates the image processing for creating data for classification process and FIG. 4B illustrate a classification process of agricultural data in an embodiment of the present invention;

FIG. 5 illustrates an area showing the sampling locations of different crop types in an embodiment of the present invention;

FIG. 6 illustrates a sampled data set of the vegetation data in an embodiment of the present invention;

FIG. 7 shows reflectance image of the exemplary geographical area showing ground sampling location of different crop types in an embodiment of the present invention;

FIG. 8 shows both datasets and the respective classes in an embodiment of the present invention.

FIG. 9 illustrates the confusion matrices which is a process of checking the accuracy of the classification process for farming analytics in an embodiment of the present invention;

FIG. 10 illustrates the confusion matrix generated for the classification of the Iris dataset as a validation of the multiclass relevance vector machine (MCRVM) data classification process in an embodiment of the present invention;

FIG. 11 illustrates the classification accuracy and training time for the MCRVM classification process in an embodiment of the present invention;

FIG. 12 illustrates the receiver operating characteristic (ROC) curve for six classes of vegetation data classification result in an embodiment of the present invention;

FIG. 13 illustrates the receiver operating characteristic (ROC) curve for three classes of Iris data classification result in an embodiment of the present invention;

FIG. 14 illustrates the sensitivity analysis of the MCRVM classification model in an embodiment of the present invention.

FIG. 15 illustrates different kernel functions used in the MCRVM classification process and their respective accuracies in an embodiment of the present invention.

### DETAILED DESCRIPTION

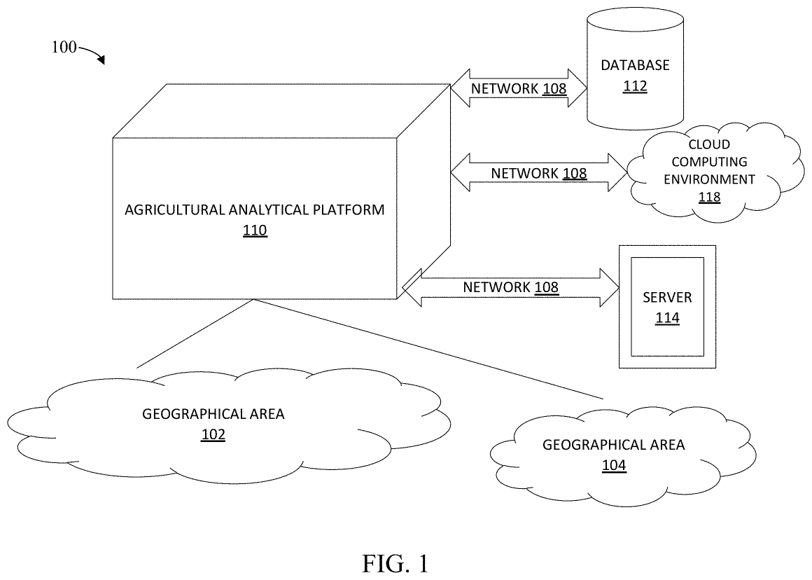

FIG. 1 illustrates the environment of a computer implemented analytical platform in an embodiment of the present invention. The environment 100 includes an agricultural analytical platform 110, a one or more geographical areas such as 102 and 104. In other embodiments, there may be more than two geographical areas that may be associated with the computer implemented agricultural analytical platform 110. The agricultural analytical platform 110 may be connected to a database 112, a server 114 and/or a cloud computing environment 118 by means of a network 108.

In some embodiments, the computer implemented agricultural analytical platform 110 may reside in the server 114 or implemented on a cloud computing environment 118.

In various embodiments, the computer database 112 associated with the computer implemented agricultural analytical platform 110 may be a distributed database, a standalone database, a flat file database, a relational database or some other type of database.

The computer implemented agricultural analytical platform 110 may employ Bayesian statistics for evolutionary computation as a modeling tool and combine it with additional ancillary data related to LAI, vegetation indices (VIs), and reflectance as inputs for multi-class classification of crops accurately.

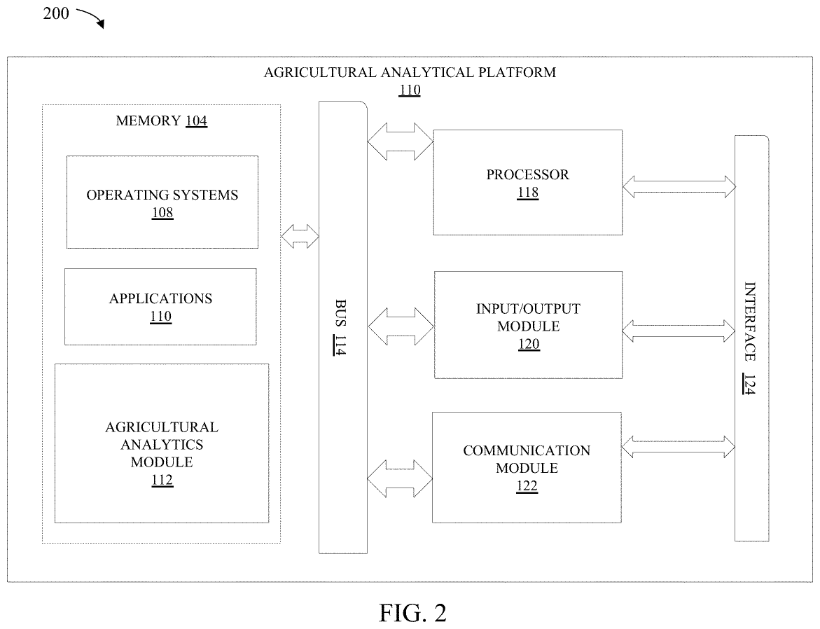

FIG. 2 illustrates the different components of a computer implemented agricultural analytical platform in an embodiment of the present invention. The computer implemented agricultural analytical platform 110 may include a memory 104, one or more processor 118, an input/output module 120, a communication module 122, an internal bus 114 and an external interface 124. The internal bus 114 allows exchange of data between the memory 104 and the processor 118, the input/output module 120, and the communication module 122. Additionally, the external interface 118 allows the computer implemented agricultural analytical platform 110 to exchange instructions/inputs/program data with different modules associated with it. In addition, the computer implemented agricultural analytical platform 110 may communicate with geographical databases and remote sensing satellites.

The memory 104 may include an operating system 108, one or more applications 110, an agricultural analytics module 112 in addition to other modules. The operating system 108 may be a windows OS, Macintosh OS, Linux OS or some other type of operating system. The one or more applications 110 may be related to agricultural data collection, crop data collection and analysis, agricultural analytics and other applications related to the agricultural analysis and management.

The agricultural analytics module 112 may include machine learning algorithms, database, and other forecasting algorithms for crop analysis, crop optimization, and crop management.

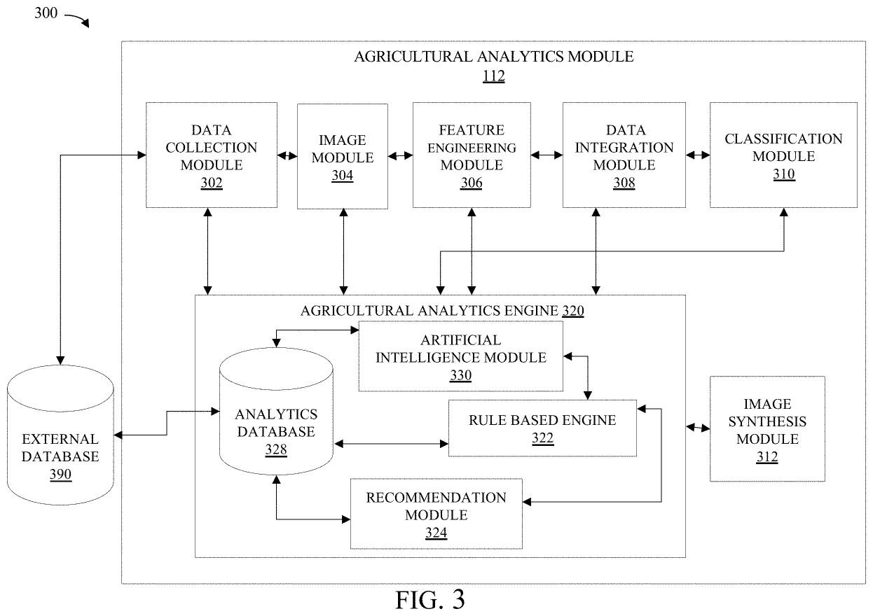

FIG. 3 illustrates different components of an agricultural analytics module in an embodiment of the present invention. The agricultural analytics module 112 may include a data collection module 302, an image module 304, a feature engineering module 306, a data integration module 308, a classification module 310, image synthesis module 312, an agricultural analytics engine 320, an external database 390 apart from other modules.

The data collection module 302 may collect data from different geographical areas and regions such as the geographical area 102. In addition, the data collection module 302 may also receive data from external sources such as, but not limited to, external database 390, which may include historical data for one or more geographical areas and geographical regions.

The image module 304 may analyse images from different agricultural regions in different formats and convert them into ASCII format for analysis. In addition, the images received from remote sensing satellite may provide additional information related to geospatial data such as data related to weather conditions, soil stratum, and atmospheric conditions.

In some embodiments, the agricultural analytics module 112 may include a feature engineering module 306. The feature engineering module 306 may extract features related to plants, plant spices, vegetation, weather conditions, ground water, soil and other aspects to be used for training the MCRVM classification model to perform multiclass classification. In some embodiments, the agricultural analytics module 112 may also perform prediction calculations related to the production (yield) of crops per square unit.

The data integration module 308 may assimilate data extracted by feature engineering module 306 and add it to the ASCII data to perform meaningful analysis of the combined data set and produce various analytical results related to framing, crops, soil, and weather. The additional data may also include crop physiological data to be used as an input within a defined level of granularity. In some embodiments, the combined use of assimilated data and location intelligence may be used to train the machine learning algorithms for accurate crop classification.

The classification module 310 may act upon the received data to produce results that allow a user to draw inferences based on the set goals. The classification module 310 is integrated with the agricultural analytics engine 320. The agricultural analytics engine 320 includes a rule-based engine 322, a recommendation module 324, an artificial intelligence module 330 and an analytics database 328. The rule-based engine 322 may implement different rules related to performing agricultural analytics to provide useful insights to the user. The analytical database 328 may include data related to farming for different geographical areas such as 102 and may also implement use of artificial intelligence algorithms. It may further include test data, training data and other data. The artificial intelligence module 330 may train and test analytical models and perform the analytics in real time.

In some embodiments, the classification module 310 and the agricultural analytics engine 320 may work in tandem to produce agricultural analytics.

The image synthesis module 312 may receive results related to machine learning, classification and agricultural analytics in a raw format such as ASCII format after the analysis of the collected data. The resultant data may be analyzed to recreate image by converting the ASCII format back to digital numbers, which may provide insights related to farming analytics. In some embodiments, the image synthesis module 312 may also use additional information from external sources such as but not limited to intelligence and date received from remote sensing satellite and may produce georeferenced, projected and classified images.

In some embodiments, the agricultural analytics engine 320 may be associated with the user interface, which may provide visual and text information related to agricultural analytics to the user.

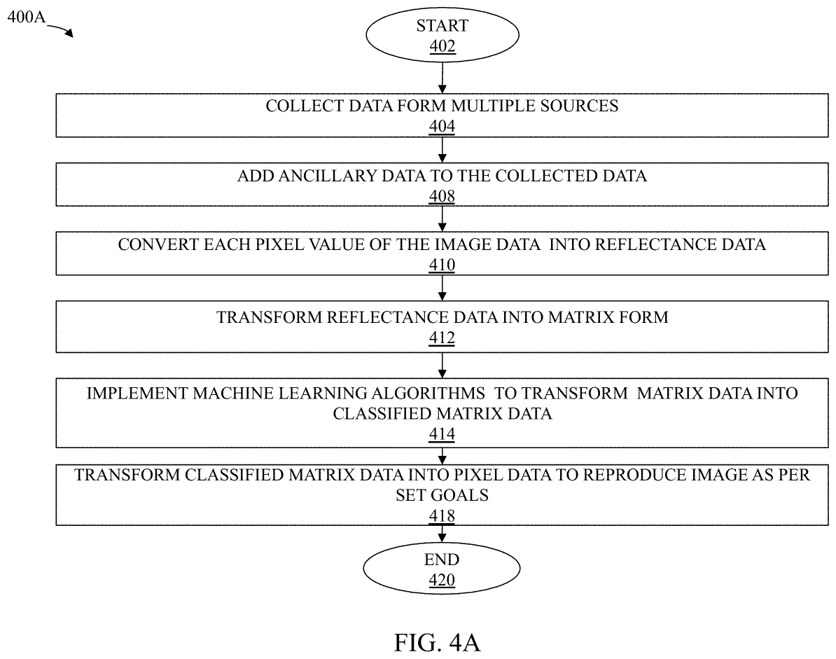

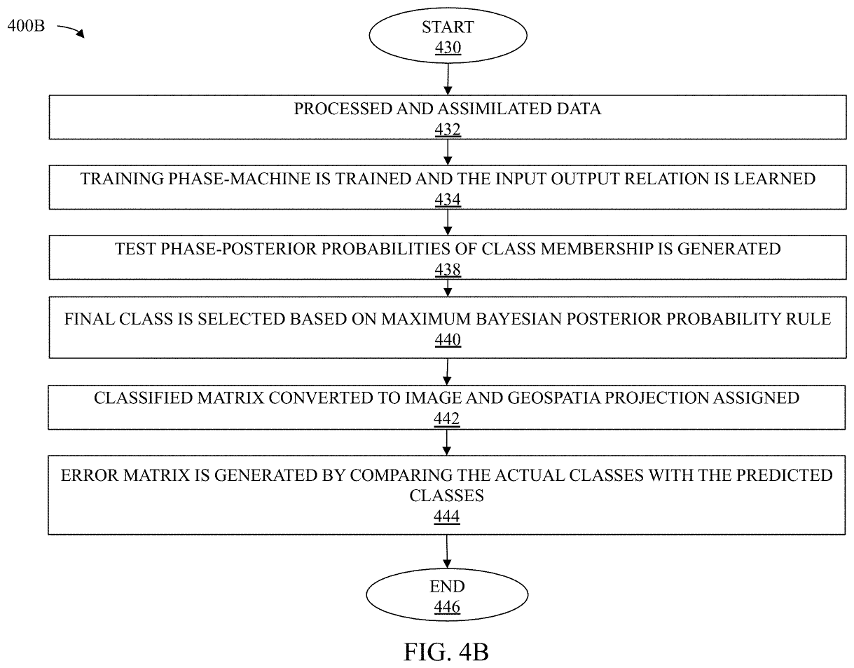

Referring to FIG. 4A, a process 400A for classification of the agricultural data as per set goals in an embodiment of the present invention is disclosed. The process 400A starts as step 402 and immediately moves to step 404. At step 404, the process 400A collects data from multiple sources including geographical and geological data. At step 408, the process 400A adds ancillary data to the collected data for analysis. In some embodiments, the step 408 may be omitted. Subsequently at step 410, the process 400A converts each pixel value of the image data into reflectance data. In embodiments, the reflectance data may be a decimals number. The reflectance data is stored in a matrix at step 412. The number matrix thus obtained is passed to the machine learning algorithms to predict/classify the agricultural data as per set goals/objectives. At step 414, the process 400A implements machine learning algorithms to transform the provided matrix data into a classified matrix data. Finally, at step 418, the classified matrix data or the predicted matrix data is transformed from the classified matrix data into pixel data to reproduce images as per set goals. Subsequently, the process 400A ends at step 420.

FIG. 4B illustrates a classification process 400B of agricultural data in an embodiment of the present invention. The process 400B starts at 430 and immediately moves to step 432. At step 432, the process 400B collects a set of assimilated data with labeled instances which are selected from a finite dataset and an inductive procedure is built to deduce an inferring function.

In some embodiments, the process 400B may involve setting up a set of goals for optimization of the agricultural data. The set goals may be related to specific objective such as, but not limited to, identifying maximum crop yield in a set of crops or identifying the best crop under specific weather conditions. At step 432, the process 400B initiates training process of the machine learning algorithm where the machine learns an input-output relationship. The process 400B may in some implementations receive the training data comprising image data. Each pixel of the image data may correspond to the reflectance value, which is a decimal value. In software implemented program each pixel value may be represented by a float data type. The pixel value of the image data is transformed into a matrix of numbers. In some implementations, the matrix of numbers may represent the reflectance value. In embodiments, the step 434 of the process 400B, may use the training data to train one or more algorithms associated with the artificial intelligence algorithms for prediction and classification. The outcome may then be reconverted into image(s) to produce results as per the set goals. The output of the algorithm is the transformed matrix of numbers that represent the outcome in the form of a georeferenced, projected and classified image.

At next step 438, the process 400B initiates the test phase, where the posterior probabilities of class membership are generated.

At step 440, the process 400B, creates a final class based on maximum Bayesian posterior probability rule. At step 442, the process 400B converts the classified matrix into image and geospatial projection assignment is performed. At step 444 of the process 400B, an error matrix is generated by comparing the actual classes with the predicted classes. The relevance vectors generated during the training phase at step 434 of process of 400B may be utilised for retraining of the agricultural analytics engine 320. The error matrix generated at step 444 may be utilised for determining the accuracy of the classification model. Finally, the process 400B terminates at step 446.

In embodiments, the process 400B may map unseen instances to their appropriate classes. Furthermore, in other embodiments, the agricultural analytics engine 320 may perform feature engineering.

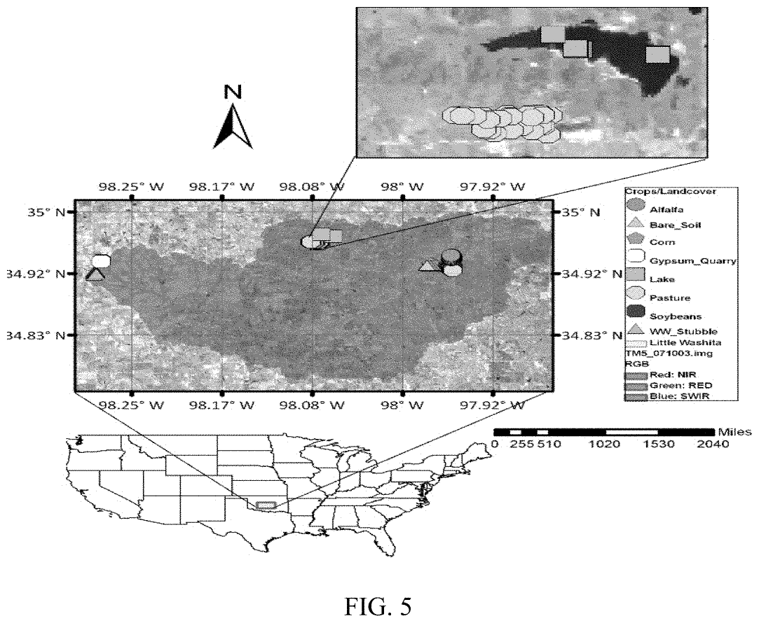

FIG. 5 illustrates an area showing the sampling locations of different crop types in an embodiment of the present invention. In this exemplary embodiment, the study area is Little Washita watershed in southwest Oklahoma, USA. The data used for the analysis was a part of the Soil Moisture Experiment (SMEX03) conducted in Oklahoma, USA in 2003. The vegetation data acquired during the experiments in the Little Washita watershed is used for analysis. The temporal coverage of the data was from 1-17 Jul. 2003.

For purpose of validation in an exemplary embodiment, the vegetation data used was downloaded from the National Snow and Ice Data Center (NSIDC) website. Several Little Washita watershed sites, which represented the dominant types of vegetation, were sampled. Sampling was performed on sites approximately 800 m×800 m in size and was concentrated in the Little Washita watershed. Reflectance and Leaf Area Index (LAI) measurements were collected at nine different sites which included measurements over a lake and a quarry for calibration purposes. The vegetation types were corn, alfalfa, soybeans, winter wheat stubble, pasture, and bare soil. Out of these, data acquired over corn, alfalfa, soybeans, bare soil, quarry and lake were used for analysis.

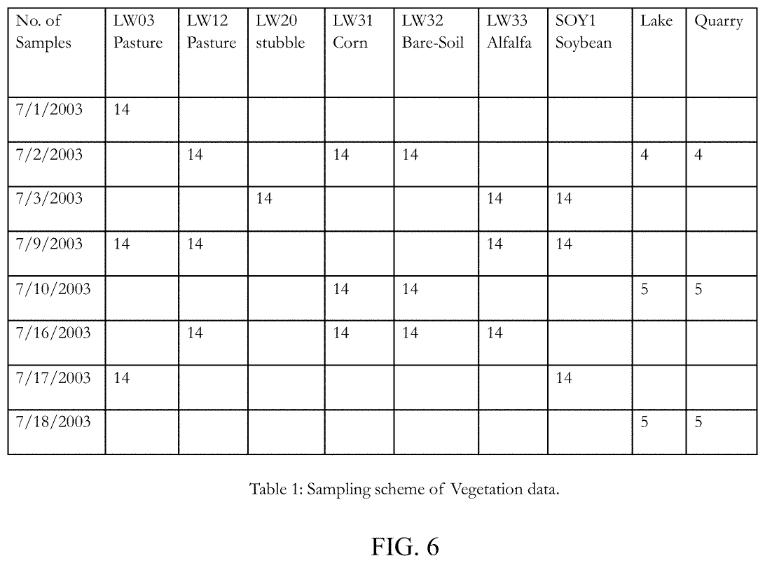

FIG. 6 illustrates a sampled data set of the vegetation data in an embodiment of the present invention. The attributes used for training the agricultural analytical model 112 were LAI (m²/m²), multispectral radiometer reflectance (%) and Vegetation Indices (VIs).

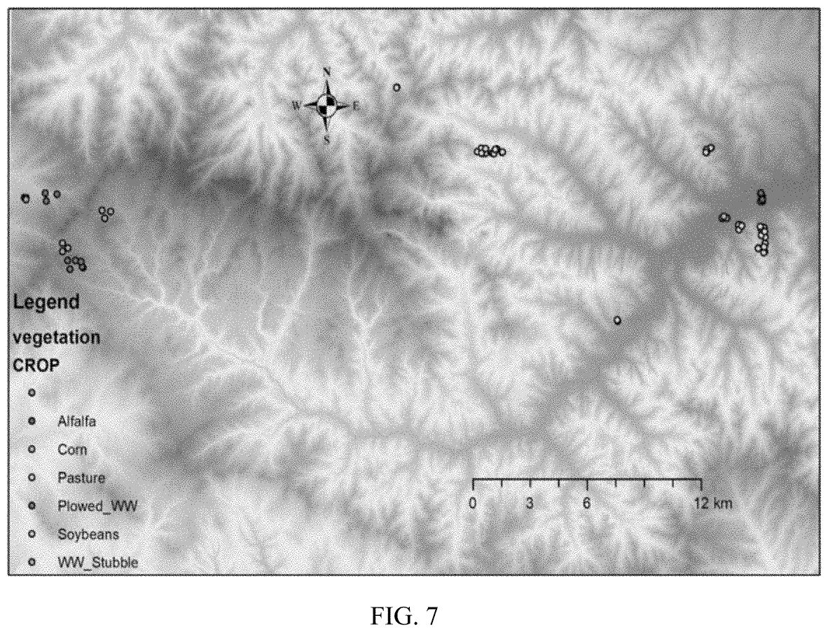

FIG. 7 illustrates the reflectance image of the exemplary geographical area showing ground sampling location of different crop types in an embodiment of the present invention. In this exemplary embodiment, the reflectance image of the geographical area, which is the Little Washita Watershed Oklahoma in the US, is shown. Each attribute used for training the analytical platform are analyzed herein.

Vegetation data—the following sections provide details of the vegetation data used in the analysis in this embodiment of the present invention.

Multi-Spectral Radiometer Reflectance Measurements

The measurement for multispectral radiometers was made by equipment CropScan to measure the reflectance. The wavelengths measured were: 485, 560, 650, 660, 830, 850, 1240, 1640, and 1650 nm bands. These bands provide data for selected channels of the Landsat Thematic Mapper and Moderate Resolution Imaging Spectroradiometer (MODIS) instruments. Channels were chosen to provide a variety of vegetation water content indices. The average percent reflectance measurements in wavebands 485, 560, 660, and 1650 nm were used directly as inputs. FIG. 7 shows reflectance imagery of the Little Washita watershed and the ground samples of six different crop types—Alfalfa, corn, pasture, plowed_WW, Soybeans, and WW_Stubble. WW_Stubble is Winter Wheat that has been harvested, Plowed_WW is Winter Wheat that has been harvested and plowed.

Leaf Area Index (LAI) Measurements

LAI is defined as the ratio of total upper leaf surface of vegetation divided by the surface area of the land on which the vegetation grows. The exemplary data was measured using LI-COR LAI-2000 plant canopy analyzers using an indirect contact method based on light transmittance through the canopy. The LAI is dimensionless (m²/m²).

Calculation of Vi's

The soil adjusted vegetation index (SAVI) and normalized difference water index (NDWI) were used as inputs. The MSR-16R multi-spectral radiometer reflectance data recorded in the bands 650, 830, 850, and 1240 nm were used to calculate the VIs. The following equations were used.

SAVI=(R_{NIR}−R_{RED})(1+L)/(R_{NIR}+R_{RED}+L) (1)

NDWI=R_{NIR}−R_{SWIR}/R_{NIR}+R_{SWIR} (2)

where, R_{NIR}, R_{RED}, R_{SWIR} are the apparent reflectance values in the near-infrared (˜0.8 μm), red (˜0.6 μm), and short-wave infrared (˜1.2-2.5 μm) wavebands, respectively. L is a calibration factor (Huete 1988). SAVI and NDWI are dimensionless.

IRIS Data Dataset

The second dataset was the Iris flower data. This is perhaps the best-known dataset found in pattern recognition. The dataset consists of three classes with 50 instances each, where each class refers to a type of Iris plant—Setosa, Versicolour, or Virginica. The dataset has four attributes: sepal length, sepal width, petal length, and petal width in cm. The classes are very similar and can only be separated by a robust classification technique.

The Agricultural Analytical Model Building

The Relevance Vector Machine was used as a machine learning and classification process in the preferred embodiment of the invention. This is an extension of the sparse Bayesian model developed to handle multiclass outputs. For preparation of the model, Thayananthan's MCRVM open access algorithm was used as the base code, which is an open source and extends Tipping's binary relevance vector machine classification scheme to a multi-class RVM, which was used for hand movement pattern recognition. This model has been used as a base to build a completely new multi-class RVM model for crop classification which uses data assimilation and produces classified crop area with projection system.

The Sparse Bayesian Learning is used to describe the application of Bayesian automatic relevance determination (ARD) concepts to models that are linear in their parameters. The approach is to infer a regression or classification model that is both accurate and sparse because it makes its predictions using only a small number of relevant basis functions that are automatically selected from a potentially large initial set. A special case of this concept is the RVM which is applied to linear kernel models.

The data set is in the form of input-output pairs, {xₙ,yₙ}ₙ₌₁^{N}. The major goal is to learn a model of dependency of the targets on the inputs with the objective of making accurate predictions for previously unseen values of x. This model is defined as some function y(x) whose parameters are found as:

$$y ( x ; w ) = {\sum }_{i = 1}^{M} {w}_{i} {φ}_{i} ( x ) = {w}^{T} φ ( x ) \qquad ( 3 )$$

where the output y(x; w) is a linearly weighted sum of M generally nonlinear and fixed basis functions, φ(x)=(φ1(x), φ2(x), . . . φM(x))T, and weights w=(w1, w2, . . . , wM)T, which are adjustable parameters. Equation (3) can result in a number of different models, of which RVMs are a special case.

This procedure is highly perceptive with a Bayesian probabilistic framework that helps in extracting predictors that are very sparse, with few non-zero w parameters. Only those basis functions that are necessary for making accurate predictions are retained.

Bayes rule states that the posterior probability of w is obtained by combining the likelihood and prior as:

p(w|t,α,σ2)=p(t|w,σ²)p(w|α)/p(t|α,σ²) (4)

where σ² is the error variance, p(t|w,σ²) is the likelihood of target t, p(w|α) is the prior, and p(t|α,σ²) is the evidence. Applying the logistic sigmoid link function σ(y)=1/(1+e−y) to y(x) and, adopting the Bernoulli distribution for p(t|w,σ²), the likelihood can be written as:

$$p ( t \vert w ) = {\prod }_{n = 1}^{N} σ {{\{ y ( {x}_{n} ; w ) \}}^{{t}_{n}} [ 1 - σ \{ y ( {x}_{n} ; w ) \} ]}^{1 - {t}_{n}} \qquad ( 5 )$$

where tₙ is the target class, which for this example lies in the set {1, 2, 3, 4, 5, 6}. In Zhang and Malik (2005) a true multiclass likelihood was specified. It was obtained by generalizing equation (5) to multinomial form given by,

$$p ( t \vert w ) = {\prod }_{n = 1}^{N} {\prod }_{k = 1}^{K} σ {\{ {y}_{k} ; {y}_{1} , {y}_{2} , … {y}_{k} \}}^{{t}_{nk}} \qquad ( 6 )$$

where the predictor yₖ of each class was coupled with the multinominal logit function given by,

$$σ ( {y}_{k} ; {y}_{1} , {y}_{2} , … {y}_{k} ) = \frac{{e}^{{y}_{k}}}{{e}^{{y}_{1}} + … + {e}^{{y}_{k}}} \qquad ( 7 )$$

For obtaining probabilistic outputs, a sigmoid link function is applied to the output y(x), f(y)=1/(1+e). A zero mean Gaussian prior distribution is applied over w and is given by,

$$p ( w \vert α ) = {\prod }_{n = 1}^{N} \sqrt{\frac{{α}_{n}}{2 π}} exp ( \frac{{α}_{n} {w}_{n}^{2}}{2} ) \qquad ( 8 )$$

Here the N independent hyperparameters, α=(α₀, α₁, . . . , α_{N})T, individually control the strength of the prior distribution over the corresponding weights and are eventually responsible for the sparsity of the model.

The closed-form expression for the weight posterior p(w|t,α,σ²) and evidence of hyperparameters p(t|α,σ²) cannot be obtained since the weights cannot be integrated out of equation 5. Hence a Laplacian approximation is used. Since p(w|t,α)∝p(t|w)p(w|α), with a fixed given α, the maximum a posteriori estimate (MAP) of weights can be obtained by maximizing log(p(w|t,α,σ²)) or by minimizing the following cost function:

$$log ( p ( w \vert t , α , {σ}^{2} ) ) = {\sum }_{n = 1}^{N} ( \frac{{α}_{n} {w}_{n}^{2}}{2} - {t}_{n} log {y}_{n} + ( 1 - {t}_{n} ) log ( 1 - {y}_{n} ) ) \qquad ( 9 )$$

The Hessian of log(p(w|t,α,σ²)) is given by,

H=∇²(log(p(w|t,α)))=Φ^{T}BΦ+A (10)

where matrix Φ is the N×(N+1) ‘design’ matrix with φₙₘ=k(xₙ,xₘ₋₁). k(xₙ,xₘ₋₁) is the Gaussian kernel and has the form: k(xₙ,xₘ₋₁)=exp(−r⁻²∥xₙ−xₘ₋₁∥²), where r is the kernel width. A=diag{α₁, . . . , αₙ}, and B=diag(β₁, β₂, . . . ,β_{N}) are diagonal matrices with βₙ=σ{y(xₙ)}[1−σ{y(xₙ)}]. The hyperparameters a are iteratively updated using the covariance Σ and mean μ_{MP} of the Gaussian approximation.

The covariance Σ is given by the inverse of the Hessian (equation 10),

Σ=(H)⁻¹(Φ^{T}BΦ+A)⁻¹ (11)

and the mean is given by,

μ_{MP}=ΣΦ^{T}B\hat{t} (12)

\hat{t}=Φμ_{MP}+B⁻¹(t−y) (13)

The following equation is used for updating the hyperparameters:

$${α}_{i}^{new} = \frac{1 - {α}_{i} {Σ}_{ii}}{{μ}_{1}^{2}} \qquad ( 14 )$$

where μᵢ denotes the i^{th} posterior mean weight from (equation 12), Σᵢᵢ is the i^{th} diagonal element of the posterior weight covariance (equation 11), and the quantity 1−αᵢEᵢᵢ is a measure of the degree to which the associated parameter wᵢ is determined by the data (Khalil and Almasri, 2005). During the re-estimation process the αᵢ tend to infinity making p(wᵢ|t,α,σ²) highly peaked at zero. This makes the associated weights zero and hence the associated basis functions are discarded, thus making the machine sparse

Data Assimilation, Training and Testing of the Agricultural Analytics Module

Two different datasets are used for training and testing the model.

The first dataset is the vegetation data from SMEX 2003 which had seven inputs (LAI, SAVI, NDWI and reflectance at 485, 560, 660 and 1650 nm) and six output classes (corn, alfalfa, soybeans, quarry, lake, and bare soil).

The second was the Iris flower dataset with four attributes (sepal length, sepal width, petal length and petal width) and three classes (Setosa, Versicolour and Virginica).

The first step in developing the classification scheme was data cleaning where missing and inconsistent data were removed. The aim was to extract the structural features from the data which would be used by the classifier to assemble a robust predictor and a generalized multiclass learning machine. The purpose is to build a model for vegetation/crop discrimination. Hence, several runs were performed with different combinations of reflectance values with VIs and LAI. It was observed that reflectance at 485, 560, 660 and 1650 nm along with SAVI, NDWI and LAI produced the best results and enhanced class separability. The VIs were calculated using reflectance in bands 650, 830, 850, and 1240 nm. The bands that were already used for the calculation of VIs were not used in the input training matrix.

After the data were assimilated, a small representative set of points were selected from the vegetation dataset through stratified random sampling for training the agricultural analytics model. The vegetation data training set comprised of 70 instances, and an independent set consisting of 125 instances was used for testing. The trained machine was then used to classify the test data.

After the test results were obtained, which were the posterior probabilities of each class, the ultimate class was selected based on the maximum Bayesian posterior probability rule applied to these posterior probabilities.

Sensitivity analysis was performed wherein LAI was removed and the model was run for the remaining six inputs. Another analysis was done with just the reflectance data to observe the effect of data assimilation. A rigorous accuracy assessment was done where the Receiver Operating Characteristic (ROC) curves, confusion matrix, and Cohen's Kappa coefficient were calculated for each dataset. The classification accuracy was expressed as the percentage of the testing cases correctly classified.

The Iris dataset was used for testing the classifier generalization capability and accuracy. The data consists of 150 instances. It was divided equally into training and testing sets of 75 instances each by stratified sampling. The multiclass agricultural analytics model with the RVM machine was trained and tested with each of these sets.

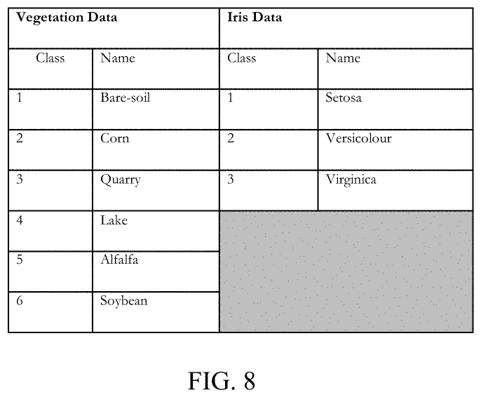

FIG. 8 shows vegetation data and the Iris flower datasets with their respective classes in an embodiment of the present invention. An assessment of classification accuracy accomplishes a broad operational evaluation of the developed analytical model. There are many classification accuracy measures reported in the literature. The most extensively used measures are derived from the error or confusion matrix. There has been an increase in the use of ROC curves in machine learning and data mining. In addition to being a useful performance graphing method, they have properties that make them especially useful for domains with skewed class distributions and unequal classification error costs. In some embodiments, the Cohen's Kappa coefficient is considered to be a robust measurement of classification accuracy. In other embodiments, the Kappa coefficient may be considered as a standard measure of classification accuracy. In embodiments, the measures of accuracy may be determined using at least one of the below techniques.

Receiver Operator Characteristic (Roc) Curves

The ROC curves analyze the hit rates/false alarm of diagnostic decision-making. Normally in a two-class problem, the area under the ROC curve (AUC) is a single scaler value, but in a multiclass problem there is a challenge of combining the multiple pairwise discriminability. In embodiments, the multiclass AUCs are calculated by producing an ROC curve for each class, measuring the area under the curve, and then adding up the AUCs weighted by the reference class's prevalence in the data. It is defined by,

$$A U {C}_{total} = {\sum }_{{c}_{i} ∈ C} A U C ( {c}_{i} ) \cdot p ( {c}_{i} ) \qquad ( 15 )$$

where AUC (cᵢ) is the area under the class reference ROC curve for cᵢ.

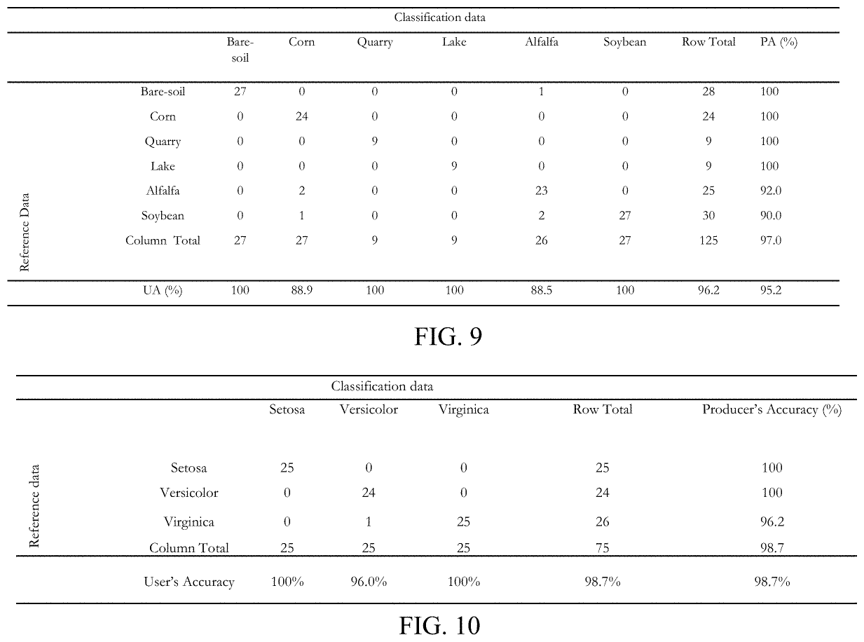

In embodiments, another technique for measuring accuracy is a confusion matrix. The confusion matrix is a tool used in supervised learning to judge the accuracy of the classifier. This method has an advantage of producing single accuracy indexes which can be used for further evaluation and comparison. FIG. 9 and FIG. 10 show the error matrices for the vegetation and iris data respectively and the user's and producer's accuracy show the model performance for each class.

In embodiments, another technique for measuring accuracy is Kappa Coefficient. The confusion matrix obtained through the multiclass RVM model may be analyzed using the Kappa coefficient, K:

$$K = \frac{N {{\sum }_{i = 1}}^{n} {x}_{ii} - {{\sum }_{i = 1}}^{n} ( {x}_{i +} \times {x}_{+ i} )}{{N}^{2} - {\sum }_{i = 1}^{n} ( {x}_{i +} \times {x}_{+ i} )}$$

where n is the number of classes, xᵢᵢ is the number of observations on the diagonal of the confusion matrix corresponding to row i and column i, xᵢ₊ and x₊ᵢ are the marginal totals of row i and column i, respectively, and N is the total number of instances.

The final classes predicted by the agricultural analytical model were compared with the original classes and of the 125 cases in the testing set of vegetation data, only 6 were misclassified. For the Iris data, out of 70 cases in the testing set, only 1 was misclassified. The overall classification accuracy obtained for the vegetation data was 95.2% as shown in FIG. 9 and Cohen's Kappa Coefficient was found to be 0.94 as shown in FIG. 10.

The kappa confidence interval was 0.867 to 0.974 which reflected the strength of the inter-rater agreement and showed that the observed agreement was not accidental. The average user's and producer's accuracy for the vegetation data was 96.23% and 97%, respectively. Of six misclassifications for the vegetation data, four were confident misallocations. In the other two, the posterior probabilities of class membership were very close. Use of LAI helped the algorithm to classify other data types such as water and quarry as these had a 0 LAI value.

The agricultural analytics model was applied to the Iris data set, which is considered as a standard benchmark in the pattern recognition literature. The accuracy achieved was 98.7%, which is at par with the maximum accuracy achieved with Iris data.

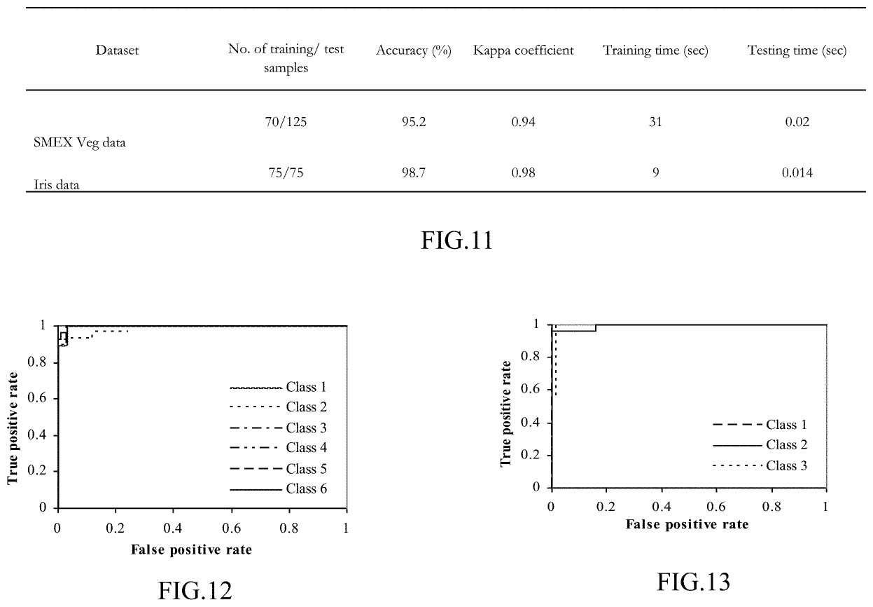

In embodiments, the average user's and producer's accuracy was 98.7% and 98.7%, respectively. The Kappa coefficient was 0.98 as shown in FIG. 11.

The inferred classifiers were sparse and used only an average of 11 RVs out of 70 training points for the SMEX vegetation dataset, and 17 RVs out of 75 training points for the Iris data. The probable reason for the larger number of RVs for the Iris data might be that one class (Setosa) is linearly separable from the other two, but the latter are not linearly separable from each other.

The multiclass AUCs were calculated by the method used by Provost and Domingos. The advantage of this AUC formulation is that AUCₜₒₜₐₗ is calculated directly from class reference ROC curves which can be generated and visualized easily. The disadvantage is that class reference ROC is sensitive to class distributions and error costs. The multiclass AUCₜₒₜₐₗ for the SMEX vegetation data was 0.995, and for the Iris data it was 0.994.

FIG. 12 illustrates the true positive (TP) rate versus False Positive (FP) rate for six classes of the SMEX vegetation data. Classes 3 (Quarry) and 4 (Lake) show perfect ROC curves. Class 1 (bare soil), class 2 (corn), class 5 (alfalfa) and class 6 (soybean) shows optimal model performance because the curves lie towards the northwest corner of the ROC space. Likewise, the Iris data as illustrated in FIG. 13 shows that all three ROC curves lie towards the northwest corner of the ROC space showing optimal performance.

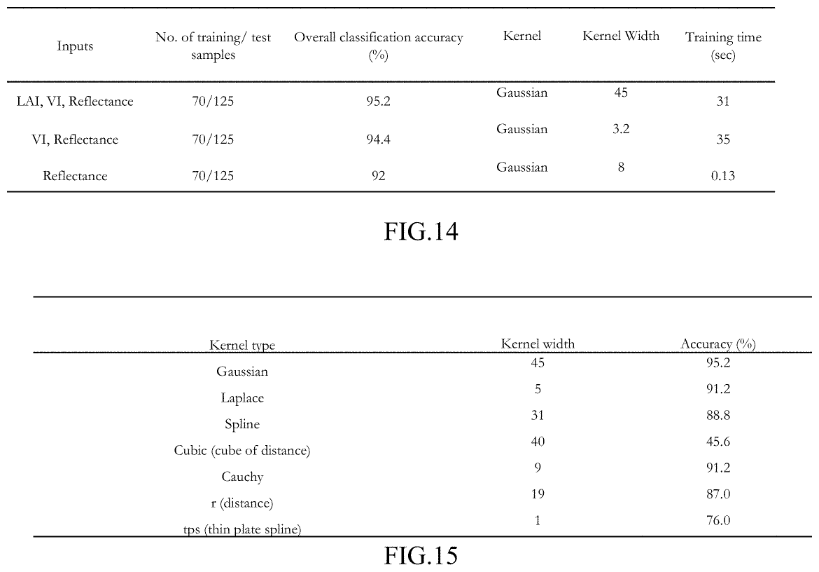

Sensitivity analysis is done to test the performance of the machine without the LAI input and then without including LAI and VI. Results show that addition of LAI to the dataset increased the accuracy by almost 1% as illustrated in FIG. 14. LAI measurement is often a part of a large experimental project like SMEX. If the data is readily available then it can be used in conjunction with other inputs which might help improve the accuracy of the learning machine. As shown in FIG. 14, the agricultural analytics classifier produced an accuracy of 92% when only the reflectance data were used, which was 3.2% less than the case where the data assimilation technique was used.

In some embodiments, the use of a Gaussian kernel resulted in the maximum accuracy of the multiclass RVM classifier, with a kernel width of 45.

FIG. 15 shows the results obtained for different kernel functions. In some embodiments, the Laplacian and Cauchy kernels may be used for accuracy determination.

UX/UI Interface

The analytics platform 110 has a user interface having features related to data ingestion and exploration, feature engineering, insights, analysis, results and presentation dashboard. The analytics platform 110 may allow the users to complete a task or achieve a specific goal, like crop classification, crop yield calculation, invasive species detection etc. Furthermore, the analytics platform 110 may in some embodiments include a Natural Language Processing (NLP) feature, where the NLP module can understand questions posed by the user in natural language.

Although specific embodiments are illustrated and described herein, it will be appreciated by those of ordinary skill in the art that any arrangement, which is calculated to achieve the same purpose, may be substituted for the specific embodiments shown. This application is intended to cover any adaptations or variations. For example, although described as applicable to certain crops, one of ordinary skill in the art will appreciate that the invention is applicable to other environments, where there may exist a need to perform similar analysis on large data sets but achieve higher predictability and better efficiency by reducing the necessary parameters for the analysis.

In particular, one of skill in the art will readily appreciate that the names of the methods and apparatus are not intended to limit embodiments. Furthermore, additional methods and apparatus can be added to the platform, functions can be rearranged among the components of the disclosed platform, and new components to correspond to future enhancements and devices used in embodiments can be introduced without departing from the scope of embodiments.

It is noted that several of the embodiments of the methods disclosed and discussed herein may be capable of performance at one or more of the components of the disclosed platform. Therefore, it will be understood to one having skill in the art to understand and practice the teachings herein at different component levels of the platform without departing from the scope of this disclosure.

1. A computer implemented analytical platform for classification and prediction of different vegetation in a geographical area, the computer implemented analytical platform comprising of:
a data collection module configured to aggregate data from a data source;
an image processing module to convert an image data, wherein each pixel of the image data has a reflectance value, the reflectance values being stored as a matrix of numbers, wherein the matrix of numbers is utilised by a machine learning artificial intelligence algorithm;
a feature engineering module configured to map a geospatial data for the geographical area;
an agricultural analytical engine implementing the machine learning algorithms, which are trained using a test dataset, wherein the test data includes selection of a set of features selected by the feature engineering module to optimise the set goals;
a recommendation module for prediction and classification based on the set goals, in the form of a classified matric of numbers; and
a resynthesis module to convert the classified matrix of numbers into an image and assign a geospatial projection to the image as per set goals.

2. The computer implemented analytical platform of claim 1, wherein the reflectance value is a float value.

3. The computer implemented analytical platform of claim 1, wherein the reflectance value corresponds to a physical property of the analyzed surface.

4. The computer implemented analytical platform of claim 1, wherein the prediction is related to one of: crop classification, classification of invasive species, and a combination of crop classification with classification of invasive species.

5. The computer implemented analytical platform of claim 1, wherein the geospatial data of the geographical area is used for prediction.

6. The computer implemented analytical platform of claim 1, wherein the aggregated data from data collection module is tested by using a supervised classification.

7. The computer implemented analytical platform of claim 1, wherein the prediction and classification from recommendation modules are validated using a statistical technique.

8. The computer implemented analytical platform of claim 1, wherein the data collection module uses a set of remotely sensed data that includes a reflectance value, a vegetation index and a crop physiological characteristic.

9. The computer implemented analytical platform of claim 1 further comprising a multiclass relevance vector machine.

10. The computer implemented analytical platform of claim 1, wherein a set of ancillary information is used by the recommendation engine to improve the prediction and classification.

11. The computer implemented analytical platform of claim 1 further comprising a machine learning model of probabilistic nature to analyse a classification error in the classification.

12. The computer implemented analytical platform of claim 6, wherein the supervised classification is based on a statistical learning theory.

13. The computer implemented analytical platform of claim 9 wherein the multiclass relevance vector machine is trained with a set of assimilated inputs that relate to the aggregated data being classified.

14. The computer implemented analytical platform of claim 9 using a set of ancillary data along with a spectral reflectance data to improve the prediction of recommendation module, and for automatic classification of the spectral data using the multiclass relevance vector machine.
